(19) United States
(12) Patent Application Publication
(10) Pub. No.: US 2021/0084143 A1
(43) Pub. Date: Mar. 18, 2021

(54) METHODS AND MOBILE DEVICES FOR COMMUNICATING AUDIO AVATAR INFORMATION USING A DIRECT POINT-TO-POINT WIRELESS PROTOCOL

(71) Applicant: SONY CORPORATION, Tokyo (JP)

(72) Inventors: Peter Isberg, Lund (SE); Kare Agardh, Rydeback (SE); Ola Thorn, Lund (SE); Petter Alexanderson, Lund (SE)

(21) Appl. No.: 16/612,147

(22) PCT Filed: May 15, 2017
(86) PCT No.: PCT/US2017/032594

§ 371 Date: Nov. 8, 2019

(51) Int. Cl. H04M 1/725; H04W 76/14; H04L 29/06; H04L 29/08; H04M 1/64; H04W 4/02

(52) U.S. Cl. CPC H04M 1/72572; H04W 76/14; H04L 65/1069; H04W 4/80; H04L 67/141; H04M 1/642; H04W 4/023; H04L 67/12

(57) ABSTRACT

A method includes performing operations as follows on a processor: establishing communication with a second mobile device using a direct point-to-point wireless protocol, obtaining an audio avatar associated with a user of the second mobile device responsive to establishing communication with the second mobile device, and playing the audio avatar on a speaker system associated with the first mobile device.

### BACKGROUND

The present disclosure relates to wireless communication, and, in particular, to communicating audio avatar information between mobile devices.

Networking, communication, and other modern technology may play an increasing role in people's lives. In particular, mobile devices, including wearable devices, such as watches, smart phones, tablets, head sets, fitness trackers, sleep monitors, and other devices with electronic sensors may provide users with an abundance of data and information to enhance their lives. Many activities, such as sporting or exercise activities, biking, driving, skiing, and the like may consume much of the participant's attention in performing or participating in the activity. Because of the participant's focus on the activity, it may be difficult for the participant to share and/or process information generated by mobile devices, such as wearable devices, with other individuals. This may be particularly problematic in high speed activities, such as driving, biking, skiing, and the like where it can be dangerous for a person to divert attention away from the activity to send to and/or process information from other individuals. As a result, the social experience during sports and other high focus activities may be lost.

### SUMMARY

In some embodiments of the inventive subject matter, a method comprises performing operations as follows on a processor of a first mobile device: establishing communication with a second mobile device using a direct point-to-point wireless protocol, obtaining an audio avatar associated with a user of the second mobile device responsive to establishing communication with the second mobile device, and playing the audio avatar on a speaker system associated with the first mobile device.

In other embodiments, establishing communication using the direct wireless connection comprises establishing communication using one of a Classic Bluetooth protocol, Bluetooth Low Energy protocol, Wireless Local Area Network (WLAN) protocol, ZigBee protocol, Infrared protocol, Device to Device (D2D) cellular, and Wi-Fi protocol.

In still other embodiments, obtaining the audio avatar associated with the user of the second mobile device comprises: receiving an identification of the user of the second mobile device via the direct point-to-point wireless protocol and downloading the audio avatar from an audio avatar server using the identification of the user of the second mobile device.

In still other embodiments, the method further comprises at least one of: performing a security protocol to access the identification of the user and performing a security protocol with the audio avatar server to download the audio avatar.

In still other embodiments, obtaining the audio avatar associated with the user of the second mobile device comprises: receiving the audio avatar from the second mobile device via the direct point-to-point wireless protocol.

In still other embodiments, the method further comprises performing a security protocol to access the audio avatar.

In still other embodiments, the method further comprises determining geolocation information associated with the first mobile device and the second mobile device using the direct point-to-point wireless protocol and modulating the playing of the audio avatar on the speaker system based on the geolocation information.

In still other embodiments, the geolocation information comprises at least one of a static distance between the first mobile device and the second mobile device, a rate of decreasing distance between the first mobile device and the second mobile device, a rate of increasing distance between the first mobile device and the second mobile device, and a direction defined by a vector extending from the first mobile device to the second mobile device.

In still other embodiments, modulating the playing of the audio avatar on the speaker system comprises at least one of adjusting a volume at which the audio avatar is played on the speaker system, adjusting a pitch at which the audio avatar is played on the speaker system, adjusting a speed at which the audio avatar is played on the speaker system, adjusting a frequency at which playback of the audio avatar is repeated on the speaker system, and adjusting a stereo effect of playback of the audio avatar on the speaker system.

In still other embodiments, the method further comprises receiving physical attribute information for the user of the second mobile device using the direct point-to-point wireless protocol and modulating the playing of the audio avatar on the speaker system based on the physical attribute information.

In still other embodiments, the physical attribute information comprises at least one of a heart rate, blood pressure, and respiration rate of the user of the second mobile device.

In some embodiments of the inventive subject matter, a method comprises performing operations as follows on a processor: defining an audio avatar for a first user associated with a first mobile device, the audio avatar being associated with an identification of the first user, receiving a request from a second mobile device associated with a second user to download the audio avatar, the request comprising the identification of the first user and being generated responsive to the first mobile device and the second mobile device establishing communication via a direct point-to-point wireless protocol, and downloading the audio avatar to the second mobile device responsive to receiving the request.

In further embodiments, the method further comprises performing a security protocol with the second mobile device to download the audio avatar.

In still further embodiments, the method further comprises downloading an audio avatar communication module to the first mobile device, the audio avatar communication module being configured to communicate the identification of the user of the first mobile device to the second mobile device via the direct point-to-point wireless protocol.

In still further embodiments, the method further comprises downloading an audio avatar modulation module to the second mobile device, the audio avatar modulation module being configured to modulate the playing of the audio avatar on a speaker system of the second mobile device based on geolocation information associated with the first mobile device and the second mobile device.

In still further embodiments, the audio avatar modulation module is further configured to modulate the playing of the audio avatar on the speaker system based on physical attribute information received at the second mobile device for the user of the first mobile device.

In some embodiments of the inventive subject matter, a mobile device comprises a processor and a computer readable storage medium comprising computer readable program code that when executed by the processor causes the processor to perform operations comprising: establishing communication with a second mobile device using a direct point-to-point wireless protocol, obtaining an audio avatar associated with a user of the second mobile device responsive to establishing communication with the second mobile device, and playing the audio avatar on a speaker system associated with the first mobile device.

In other embodiments, establishing communication using the direct wireless connection comprises establishing communication using one of a Classic Bluetooth protocol, Bluetooth Low Energy protocol, Wireless Local Area Network (WLAN) protocol, ZigBee protocol, Infrared protocol, Device to Device (D2D) cellular, and Wi-Fi protocol.

In still other embodiments, the operations further comprise: determining geolocation information associated with the first mobile device and the second mobile device using the direct point-to-point wireless protocol, receiving physical attribute information for the user of the second mobile device using the direct point-to-point wireless protocol, and modulating the playing of the audio avatar on the speaker system based on at least one of the geolocation information and the physical attribute information. The geolocation information comprises at least one of a static distance between the first mobile device and the second mobile device, a rate of decreasing distance between the first mobile device and the second mobile device, a rate of increasing distance between the first mobile device and the second mobile device, and a direction defined by a vector extending from the first mobile device to the second mobile device, and modulating the playing of the audio avatar on the speaker system comprises at least one of adjusting a volume at which the audio avatar is played on the speaker system, adjusting a pitch at which the audio avatar is played on the speaker system, adjusting a speed at which the audio avatar is played on the speaker system, adjusting a frequency at which playback of the audio avatar is repeated on the speaker system, and adjusting a stereo effect of playback of the audio avatar on the speaker system.

In still other embodiments, the mobile device is one of a wearable device and a vehicular apparatus.

Other methods, systems, devices, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a communication network for facilitating communication of audio avatar information using a direct point-to-point wireless protocol in accordance with some embodiments of the inventive subject matter.

FIG. 2 illustrates a data processing system that may be used to implement the audio avatar server of FIG. 1 in accordance with some embodiments of the inventive subject matter.

FIG. 3 is a block diagram that illustrates an electronic device/mobile device in accordance with some embodiments of the present inventive subject matter.

FIGS. 4 and 5 are flowcharts that illustrate operations for facilitating communication of audio avatar information using a direct point-to-point wireless protocol in accordance with some embodiments of the inventive subject matter.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As used herein, the term “data processing facility” includes, but it not limited to, a hardware element, firmware component, and/or software component. A data processing system may be configured with one or more data processing facilities.

As used herein, the term “mobile terminal” or “mobile device” may include a satellite or cellular radiotelephone with or without a multi-line display; a Personal Communications System (PCS) terminal that may combine a cellular radiotelephone with data processing, facsimile and data communications capabilities; a PDA or smart phone that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals or mobile devices may also be referred to as “pervasive computing” devices. Mobile terminals or mobile devices may also encompass wearable technology, wearables, fashionable technology, wearable devices, tech togs, and/or fashion electronics, which are smart electronic devices (i.e., electronic device with microcontroller) that can be worn on the body, implanted in the body, and/or as an accessory to other clothing. The designs often incorporate practical functions and features. Wearable devices may include, but are not limited to, head sets, headphones, fitness tracker devices, sleep tracker devices, navigation devices, watches, eyeglasses, and ear pieces. In addition, mobile terminals or mobile devices may also encompass vehicular apparatus including, but not limited to, automobiles, trucks, buses, trains, and planes.

For purposes of illustration, embodiments of the present invention are described herein in the context of a mobile terminal or mobile device. It will be understood, however, that the present invention is not limited to such embodiments and may be embodied generally as an electronic device that is configured to transmit, receive, and/or process an audio avatar using a direct point-to-point wireless protocol.

Some embodiments of the inventive subject matter stem from a realization that short range wireless technology protocols, such as Classic Bluetooth, Bluetooth Low Energy, Wireless Local Area Network (WLAN), ZigBee, Infrared, Device to Device (D2D) cellular, Wi-Fi, and the like may be used as a direct point-to-point wireless protocol to communicate audio avatar information associated with a user of a second mobile device to a first mobile device. In some embodiments, the two mobile devices may establish communication using the point-to-point wireless protocol and the first mobile device may obtain an audio avatar associated with the user of the second mobile device. The audio avatar may be obtained in a variety of ways. For example, an identification of the user of the second mobile device may be communicated to the first mobile device using the point-to-point wireless protocol. This identification can then be used to download the audio avatar from an audio server. Alternatively, the audio avatar may be stored on the second mobile device and communicated directly to the first mobile device using the point-to-point wireless protocol. The audio avatar may be played on a speaker system associated with the first mobile device. As a result, the user of the first mobile device may be made aware that the user of the second mobile device is nearby without having to interact with a mobile device to communicate with the user of the second mobile device. For example, if the two users are engaged in an activity, such as skiing, biking, driving, or the like, which benefits from focus on the activity to ensure safety, then one person may be made aware of another person's presence nearby without distracting from the primary activity that the person is engaged in. In some embodiments in which one of the mobile devices is a vehicle apparatus, such as a car, truck, motorcycle, or the like, other mobile devices may be associated structures on the roadway, such as road divider lines, stop signs or stop lights, bridge structures, and the like, such that if the vehicle approaches such structures at too great a speed or gets within a defined proximity limit of such structures an audio signal may be played through the vehicles audio system in such a way to alert the driver of the structure nearby, i.e., with increasing volume, repetition frequency, or the like, as the vehicle gets closer to the structure. Similar warning functionality can be provided to drivers of different vehicles as the vehicles approach one another.

In some embodiments, playback of the audio avatar may be modulated based on geolocation information and/or physical attribute information. For example, the volume, pitch, speed, repeat frequency, and/or stereo effect may be adjusted during playback of the audio avatar based on one or both of the geolocation information and/or the physical attribute information. The geolocation information may include, but is not limited to, static distance between the first mobile device and the second mobile device, a rate of decreasing distance between the first mobile device and the second mobile device, a rate of increasing distance between the first mobile device and the second mobile device, and a direction defined by a vector extending from the first mobile device to the second mobile device. The physical attribute information may include, but is not limited to, heart rate, blood pressure, and respiration rate of the user whose identification is represented by the avatar.

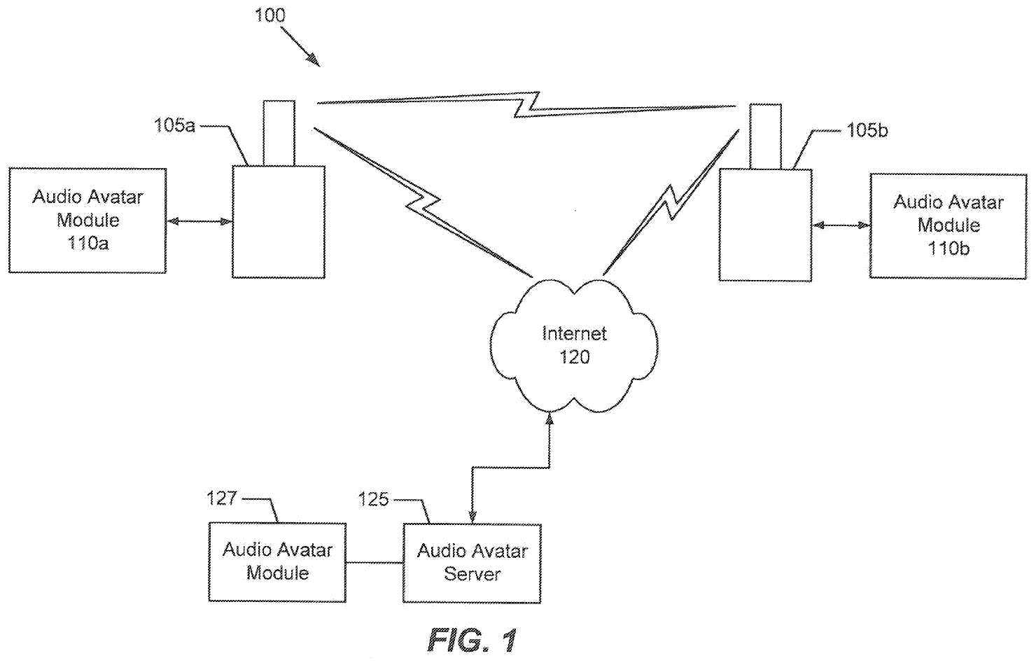

FIG. 1 is a block diagram of a communication network for facilitating communication of audio avatar information using a direct point-to-point wireless protocol in accordance with some embodiments of the inventive subject matter. As shown in FIG. 1, two users may be associated with two different mobile devices 105a and 105b, respectively. The mobile devices 105a and 105b may be configured with cellular radio frequency technology to allow the mobile devices 105a and 105b to communicate with each other and other devices using cellular wireless networks. The mobile devices 105a and 105b may also be configured to communicate with each other and/or other devices and system using a direct point-to-point short-range wireless technology, such as the Classic Bluetooth protocol, Bluetooth Low Energy protocol, Wireless Local Area Network (WLAN) protocol, ZigBee protocol, Infrared protocol, Device to Device (D2D) cellular, and/or the Wi-Fi protocol. The mobile devices 105a and 105b may further be configured to communicate with other devices and systems via the network 120, which may comprise the Internet. In some embodiments, one or both of the users of mobile devices 105a and 105b may use the mobile devices 105a and 105b or other devices suitable for communication over the network 120 to communicate with an audio avatar server 125. The audio avatar server 125 may provide an application through which a user may define an audio avatar that represents the user. In accordance with various embodiments, the audio avatar server 125 may store the defined audio avatar for the user in a repository and/or the defined audio avatar may be downloaded to a device or system of the user's choice.

The audio avatar server 125 may further comprise an audio avatar module 127 that may be downloaded to the mobile devices 105a and 105b as audio avatar modules 110a and 110b. The audio avatar modules 110a and 110b may be configured to provide functionality for communication of audio avatar information using a direct point-to-point wireless protocol. The users of mobile devices 105a and 105b may be engaged in activities, for example, that consume much of the user's focus and attention. These activities may include, for example, various sports and exercise activities, driving, and the like. As a result, the mobile devices 105a and 105b may, in some embodiments, be wearable mobile devices that allow the users to engage in other activities while still providing convenient communication access. The audio avatar modules 110a and 110b may allow the mobile devices 105a and 105b to communicate audio avatar information therebetween using the direct point-to-point short range wireless protocol and to play the audio avatar on an associated speaker system to allow a user to be notified of the presence of another person. Moreover, the communication and playing of the audio avatar may notify a person of another person's presence nearby without the need to interact with a mobile device to send a text, read a text, establish a call, or the like, which may cause an unsafe distraction depending on the type of activity a person is engaged in.

As shown in FIG. 1, the connections between the audio avatar server 125 and the mobile devices 105a and 105b may include wireless and/or wireline connections and may be direct or include one or more intervening local area networks, wide area networks, and/or the Internet. The network 120 may be a global network, such as the Internet or other publicly accessible network. Various elements of the network 120 may be interconnected by a wide area network, a local area network, an Intranet, and/or other private network, which may not be accessible by the general public. Thus, the communication network 120 may represent a combination of public and private networks or a virtual private network (VPN). The network 120 may be a wireless network, a wireline network, or may be a combination of both wireless and wireline networks.

Although FIG. 1 illustrates a communication network for facilitating communication of audio avatar information using a direct point-to-point wireless protocol according to some embodiments of the inventive subject matter, it will be understood that embodiments of the present invention are not limited to such configurations, but are intended to encompass any configuration capable of carrying out the operations described herein.

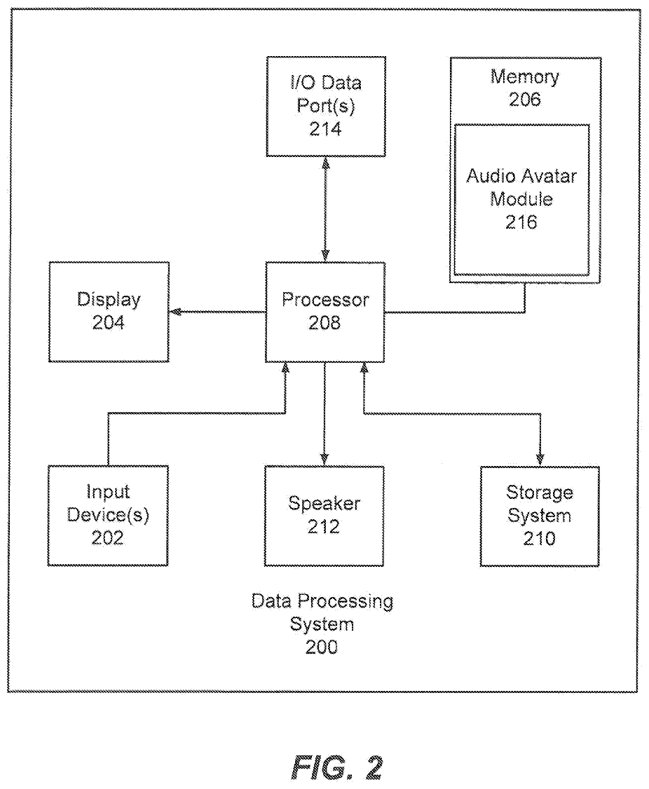

Referring now to FIG. 2, a data processing system 200 that may be used to implement the audio avatar server 125 of FIG. 1, in accordance with some embodiments of the inventive subject matter comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, flash drives, USB drives, hard disks, or the like, as well as virtual storage, such as a RAMDISK or cloud storage. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with an audio avatar module 216 that may be configured to provide the audio avatar module 127 and the audio avatar modules 110a and 110b of FIG. 1 according to some embodiments of the inventive subject matter.

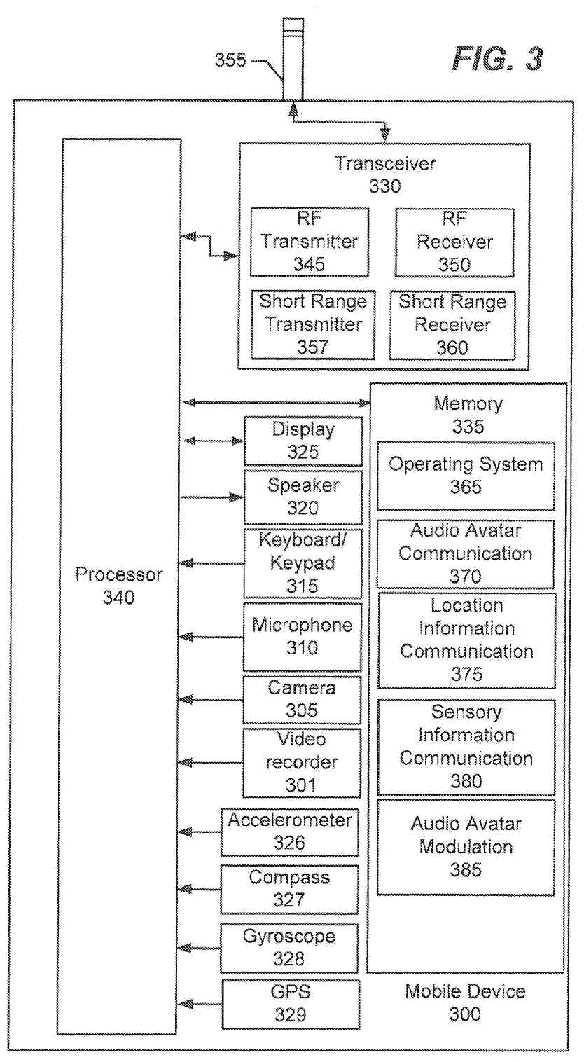

Referring now to FIG. 3, an exemplary mobile device 300 that may be used to implement the mobile terminals 105a and 105b of FIG. 1, in accordance with some embodiments of the inventive subject matter, includes a video recorder 302, a camera 305, a microphone 310, a keyboard/keypad 315, a speaker 320, a display 325, a transceiver 330, and a memory 335 that communicate with a processor 340. The transceiver 330 comprises a radio frequency transmitter circuit 345 and a radio frequency receiver circuit 350, which respectively transmit outgoing radio frequency signals to base station transceivers and receive incoming radio frequency signals from the base station transceivers via an antenna 355. The radio frequency signals transmitted between the mobile device 300 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The transceiver 330 further comprises a point-to-point short-range wireless transmitter circuit 357 and a point-to-point short-range wireless receiver circuit 360, which respectively transmit and receive short-range wireless signals corresponding to short range wireless technology protocols including, but not limited to, Classic Bluetooth, Bluetooth Low Energy, Wireless Local Area Network (WLAN), ZigBee, Infrared, Device to Device (D2D) cellular, and Wi-Fi. The foregoing components of the mobile device 300 may be included in many conventional mobile devices and their functionality is generally known to those skilled in the art.

The processor 340 communicates with the memory 335 via an address/data bus. The processor 340 may be, for example, a commercially available or custom microprocessor. The memory 335 is representative of the one or more memory devices containing the software and data used to facilitate communication of audio avatar information using a direct point-to-point wireless protocol in accordance with some embodiments of the inventive subject matter. The memory 335 may include, but is not limited to, the following types of devices: cache, ROM, PROM, EPROM, EEPROM, flash, SRAM, and DRAM.

As shown in FIG. 3, the memory 335 may contain up to five or more categories of software and/or data: an operating system 365, au audio avatar communication module 370, a location information communication module 375, a sensory information communication module 380, and an audio avatar modulation module 385.

The operating system 365 generally controls the operation of the mobile device 300. In particular, the operating system 365 may manage the mobile device's software and/or hardware resources and may coordinate execution of programs by the processor 340. The audio avatar communication module 370, the location information communication module 375, the sensory information communication module 380, and the audio avatar modulation module 385 in combination may correspond to the audio avatar module 110a, 110b, and the audio avatar module 127 of FIG. 1.

The audio avatar communication module 370 may be configured to establish communication with other devices, systems, and the like to communicate an audio avatar and/or information associated therewith. In some embodiments, the mobile device 300 may establish communication with another mobile device each equipped with the audio avatar communication module 370. The two mobile devices may establish communication using the point-to-point short-range wireless protocol and, by way of each mobile device using the audio avatar communication module 370, the first mobile device may obtain an audio avatar associated with the user of the second mobile device. The audio avatar may be obtained in a variety of ways. For example, an identification of the user of the second mobile device may be communicated via the audio avatar communication module 370 to the first mobile device using the point-to-point wireless protocol. This identification can then be used to download the audio avatar from the audio avatar server 125 using the audio avatar communication module 370. Alternatively, the audio avatar may be stored on the second mobile device and, using the audio avatar module 370, communicated directly to the first mobile device using the point-to-point wireless protocol.

The location information communication module 375 may be configured to analyze received point-to-point short range wireless protocol signals transmitted from another mobile device to determine location information from the signals. For example, the location information communication module 375 may be configured to perform a Received Signal Strength Indicator (RSSI) analysis on incoming signals to determine geolocation information corresponding to the other mobile device. Certain short range point-to-point wireless protocols may have location functionality features available, such as the proximity sensing functionality provided via the Bluetooth low energy protocol and the angle of arrival technology provided by the Bluetooth protocol. In other embodiments, the location information communication module 375 may obtain position/geolocation information generated by the accelerometer 326, compass 327, gyroscope 328, and or Global Positioning System (GPS) module 329, which can be provided to another mobile device using the audio avatar communication module 370 as location information for processing thereon via a location information communication module 375 on that device. The geolocation information may include, but is not limited to, static distance between a first mobile device and a second mobile device, a rate of decreasing distance between the first mobile device and the second mobile device, a rate of increasing distance between the first mobile device and the second mobile device, and a direction defined by a vector extending from the first mobile device to the second mobile device.

The sensory information communication module 380 may be configured to obtain and transmit physical attribute information of a user of the mobile device 300 to another mobile device and to receive physical attribute information of a user of another mobile on the mobile device 300 for processing. For example, according to some embodiments of the inventive subject matter, a mobile device may comprise a wearable device including one or more sensors. These sensors may be used to obtain physical attribute information from a user that can be communicated to another device using the sensory information communication module 380 and the audio avatar communication module 370. The physical attribute information may include, but is not limited to, heart rate, blood pressure, and respiration rate of the user.

The audio avatar modulation module 385 may be configured to modulate playback of the audio avatar on the speaker system 320 based on the geolocation information and/or the physical attribute information. For example, the volume, pitch, speed, repeat frequency, and/or stereo effect may be adjusted during playback of the audio avatar based on one or both of the geolocation information and the physical attribute information. The playback of the audio avatar on the speaker system 320 may make the user of the mobile device 300 aware that the user of a second mobile device is nearby without having to interact with the mobile device 300 to communicate with the user of the second mobile device. The various modulation techniques can be associated with the current status of the user of the second mobile device, i.e., is the user approaching quickly or slowly, is the user's heart rate or respiration rate elevated indicating the user may be fatigued or possibly approaching at a rapid rate, and the like. In some embodiments, the stereo effect may be applied to indicate a direction in which the user of the second mobile device may be approaching based on, for example, geolocation information derived from Bluetooth angle of arrival detection technology.

Although FIG. 3 illustrates an exemplary software and hardware architecture that may be used for facilitating communication of audio avatar information using a direct point-to-point wireless protocol on mobile devices according to some embodiments of the inventive subject matter, it will be understood that embodiments of the present invention are not limited to such a configuration, but are intended to encompass any configuration capable of carrying out the operations described herein.

Computer program code for carrying out operations of data processing systems discussed above with respect to FIGS. 1-3 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the audio avatar server 125 of FIG. 1, data processing system 200 of FIG. 2, and mobile device 300 of FIG. 3 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

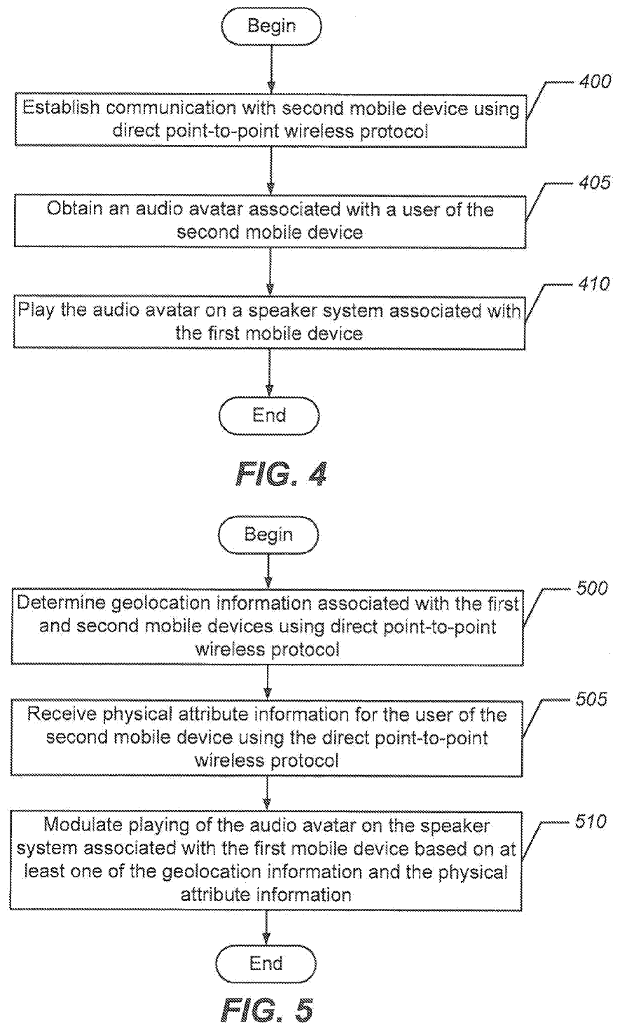

FIGS. 4 and 5 are flowcharts that illustrate operations for facilitating communication of audio avatar information using a direct point-to-point wireless protocol on mobile devices in accordance with some embodiments of the inventive subject matter.

Referring to FIGS. 1, 3, and 4, operations begin at block 400 where the audio avatar communication module 370 on the mobile device 105a establishes communication with a second mobile device 105b using a direct point-to-point wireless protocol. The first mobile device 105a may obtain an audio avatar associated with the user of the second mobile device 105b at block 405. The audio avatar may be obtained in a variety of ways. For example, an identification of the user of the second mobile device 105b may be communicated via the audio avatar communication module 370 to the first mobile device 105b using the point-to-point wireless protocol. This identification can then be used to download the audio avatar from the audio avatar server 125 using the audio avatar communication module 370. Alternatively, the audio avatar may be stored on the second mobile device 105b and, using the audio avatar module 370, communicated directly to the first mobile device using the point-to-point wireless protocol. In accordance with various embodiments of the inventive subject matter, the identification of the user of the second mobile device 105b and/or the audio avatar may be protected by a security mechanism, such as password protection, encryption, or other suitable form of security. Thus, the mobile device 105a may require authorization from the audio avatar server 125 before the audio avatar is made available for downloading. Similarly, the mobile device 105a may be required to provide a password, perform a decryption, or other form of authorization before accessing the identification of the user of the second mobile device 105b and/or accessing the audio avatar provided from the audio avatar server 125 and/or the mobile device 105b. Returning to FIG. 4, the audio avatar module 385 of the mobile device 105a plays the audio avatar associated with the user of the second mobile device 105b at block 410 on the speaker system 320 associated with the mobile device 105a.

As described above, the audio avatar modulation module 385 may modulate the playing of the audio avatar on the mobile device 105a based on geolocation information and/or physical attribute information associated with the user of the mobile device 105b. The various modulation techniques can be associated with the current status of the user of the second mobile device 105b, which, as a result, may inform the user of the mobile device 105a about how fast or slow the user of the second mobile device 105b is approaching, whether the user of the second mobile device 105b is fatigued or is highly stressed, a general direction in which the user of the second mobile device 105b is approaching, and other potentially helpful information to the user of the mobile device 105a. Such operations will now be described with reference to FIG. 5.

Referring now to FIG. 5, operations begin at block 500 where the location information communication module 375 of the mobile device 105a determines geolocation information associated with the mobile device 105a and the mobile device 105b using the direct point-to-point wireless protocol. As described above, the location information communication module 375 may be configured to perform a RSSI analysis on incoming signals to determine geolocation information corresponding to the mobile device 105b. The location information communication module 375 may also use proximity sensing technology that may be provided as part of the direct point-to-point wireless protocol and/or functionality, such as the angle of arrival technology provided by the Bluetooth protocol, for example. In other embodiments, the location information communication module 375 on the mobile device 105b may obtain position/geolocation information generated by the accelerometer 326, compass 327, gyroscope 328, and or GPS module 329, which can be provided to the mobile device 105a. The geolocation information may include, but is not limited to, static distance between the first and second mobile devices 105a and 105b, a rate of decreasing distance between the first and second mobile devices 105a and 105b, a rate of increasing distance between the first and second mobile devices 105a and 105b, and a direction defined by a vector extending from the first mobile device 105a to the second mobile device.

Returning to FIG. 5, the sensory information communication module 380 of the first mobile device 105a may receive physical attribute information for the user of the second mobile device 105b using the direct point-to-point wireless protocol at block 505. As described above, the physical attribute information may include, but is not limited to, heart rate, blood pressure, and respiration rate of the user. At block 510, the audio avatar modulation module 385 may modulate the playing of the audio avatar on the speaker system 320 associated with the mobile device 105a based on at least one of the geolocation information and the physical attribute information. In accordance with various embodiments of the inventive subject matter, the volume, pitch, speed, repeat frequency, and/or stereo effect may be adjusted during playback of the audio avatar based on one or both of the geolocation information and the physical attribute information.

Embodiments of the inventive concept may, therefore, provide mobile devices, systems, methods, and computer program products that can allow users of mobile devices to be identified by an audio avatar. The audio avatar may be a specific tone, a combination of tones, a tune, or the like that is encoded in audio samples. When an audio avatar is played on a mobile device, it may be modulated based on geolocation information associated with the mobile device and the mobile device of the user corresponding to the audio avatar and/or physical attribute information associated with the user corresponding to the audio avatar. Using various technologies, such as Bluetooth angle of arrival detection, GPS, RSSI, and the like, the direction of approach of the user associated with the audio avatar may be estimated and communicated through modulation of the audio avatar during playback. Communication between mobile devices supporting the audio avatar embodiments described herein may be supported via a short-range direct point-to-point wireless protocol. The direct point-to-point wireless protocol may be used to communicate both geolocation information and/or physical attribute information between mobile devices as well as identification information for obtaining a user's audio avatar and/or the audio avatar itself. Security mechanisms may be used to ensure that only those individuals to whom a user wants to share the user's audio avatar can gain access to the audio avatar.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items. It will be understood that when an element is referred to as being “connected” or “coupled” to another element or that a connection, such as a communication connection is established between two elements, it may be directly connected or coupled to the other element or intervening elements may be present. A direct coupling or connection between two elements means that no intervening elements are present. Like reference numbers signify like elements throughout the description of the figures.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
performing operations as follows on a processor of a first mobile device:
establishing communication with a second mobile device using a direct point-to-point wireless protocol;
obtaining an audio avatar associated with a user of the second mobile device responsive to establishing communication with the second mobile device; and
playing the audio avatar on a speaker system associated with the first mobile device.

2. The method of claim 1, wherein establishing communication using the direct wireless connection comprises establishing communication using one of a Classic Bluetooth protocol, Bluetooth Low Energy protocol, Wireless Local Area Network (WLAN) protocol, ZigBee protocol, Infrared protocol, Device to Device (D2D) cellular, and Wi-Fi protocol.

3. The method of claim 1, wherein obtaining the audio avatar associated with the user of the second mobile device comprises:
receiving an identification of the user of the second mobile device via the direct point-to-point wireless protocol; and
downloading the audio avatar from an audio avatar server using the identification of the user of the second mobile device.

4. The method of claim 3, further comprising at least one of:
performing a security protocol to access the identification of the user; and
performing a security protocol with the audio avatar server to download the audio avatar.

5. The method of claim 1, wherein obtaining the audio avatar associated with the user of the second mobile device comprises:
receiving the audio avatar from the second mobile device via the direct point-to-point wireless protocol.

6. The method of claim 5, further comprising:
performing a security protocol to access the audio avatar.

7. The method of claim 1, further comprising:
determining geolocation information associated with the first mobile device and the second mobile device using the direct point-to-point wireless protocol; and
modulating the playing of the audio avatar on the speaker system based on the geolocation information.

8. The method of claim 7, wherein the geolocation information comprises at least one of a static distance between the first mobile device and the second mobile device, a rate of decreasing distance between the first mobile device and the second mobile device, a rate of increasing distance between the first mobile device and the second mobile device, and a direction defined by a vector extending from the first mobile device to the second mobile device.

9. The method of claim 8, wherein modulating the playing of the audio avatar on the speaker system comprises at least one of adjusting a volume at which the audio avatar is played on the speaker system, adjusting a pitch at which the audio avatar is played on the speaker system, adjusting a speed at which the audio avatar is played on the speaker system, adjusting a frequency at which playback of the audio avatar is repeated on the speaker system, and adjusting a stereo effect of playback of the audio avatar on the speaker system.

10. The method of claim 9, further comprising:
receiving physical attribute information for the user of the second mobile device using the direct point-to-point wireless protocol; and
modulating the playing of the audio avatar on the speaker system based on the physical attribute information.

11. The method of claim 10, wherein the physical attribute information comprises at least one of a heart rate, blood pressure, and respiration rate of the user of the second mobile device.

12. A method, comprising:
performing operations as follows on a processor:
defining an audio avatar for a first user associated with a first mobile device, the audio avatar being associated with an identification of the first user;
receiving a request from a second mobile device associated with a second user to download the audio avatar, the request comprising the identification of the first user and being generated responsive to the first mobile device and the second mobile device establishing communication via a direct point-to-point wireless protocol; and
downloading the audio avatar to the second mobile device responsive to receiving the request.

13. The method of claim 12, further comprising:
performing a security protocol with the second mobile device to download the audio avatar.

14. The method of claim 12, further comprising:
downloading an audio avatar communication module to the first mobile device, the audio avatar communication module being configured to communicate the identification of the user of the first mobile device to the second mobile device via the direct point-to-point wireless protocol.

15. The method of claim 12, further comprising:
downloading an audio avatar modulation module to the second mobile device, the audio avatar modulation module being configured to modulate the playing of the audio avatar on a speaker system of the second mobile device based on geolocation information associated with the first mobile device and the second mobile device.

16. The method of claim 15, wherein the audio avatar modulation module is further configured to modulate the playing of the audio avatar on the speaker system based on physical attribute information received at the second mobile device for the user of the first mobile device.

17. A mobile device, comprising:
a processor; and
a computer readable storage medium comprising computer readable program code that when executed by the processor causes the processor to perform operations comprising:
establishing communication with a second mobile device using a direct point-to-point wireless protocol;
obtaining an audio avatar associated with a user of the second mobile device responsive to establishing communication with the second mobile device; and
playing the audio avatar on a speaker system associated with the first mobile device.

18. The mobile device of claim 17, wherein establishing communication using the direct wireless connection comprises establishing communication using one of a Classic Bluetooth protocol, Bluetooth Low Energy protocol, Wireless Local Area Network (WLAN) protocol, ZigBee protocol, Infrared protocol, Device to Device (D2D) cellular, and Wi-Fi protocol.

19. The mobile device of claim 17, wherein the operations further comprise:
determining geolocation information associated with the first mobile device and the second mobile device using the direct point-to-point wireless protocol;
receiving physical attribute information for the user of the second mobile device using the direct point-to-point wireless protocol; and
modulating the playing of the audio avatar on the speaker system based on at least one of the geolocation information and the physical attribute information;
wherein the geolocation information comprises at least one of a static distance between the first mobile device and the second mobile device, a rate of decreasing distance between the first mobile device and the second mobile device, a rate of increasing distance between the first mobile device and the second mobile device, and a direction defined by a vector extending from the first mobile device to the second mobile device; and
wherein modulating the playing of the audio avatar on the speaker system comprises at least one of adjusting a volume at which the audio avatar is played on the speaker system, adjusting a pitch at which the audio avatar is played on the speaker system, adjusting a speed at which the audio avatar is played on the speaker system, adjusting a frequency at which playback of the audio avatar is repeated on the speaker system, and adjusting a stereo effect of playback of the audio avatar on the speaker system.

20. The mobile device of claim 17, wherein the mobile device is one of a wearable device and a vehicular apparatus.
